(19) United States
(12) Patent Application Publication
(10) Pub. No.: US 2023/0331331 A1
(43) Pub. Date: Oct. 19, 2023

(54) Air deflector for bicycles

(71) Applicant: Jean Bellemare, Mirabel (CA)

(72) Inventor: Jean Bellemare, Mirabel (CA)

(21) Appl. No.: 18/134,579

(22) Filed: Apr. 14, 2023

(30) Foreign Application Priority Data
Apr. 15, 2022 (GB) 2205624.6

(51) Int. Cl. B62J 17/04; B62J 6/02

(52) U.S. Cl. CPC B62J 17/04; B62J 6/02

(57) ABSTRACT

An air deflector for bicycles, having a handlebar clamp mechanically fastened to the handlebars of a bicycle. A base plate mechanically fastened to the at least one handlebar clamp. A pivot bracket comprised by the base plate. A deflector connector that is rotationally connected to the pivot bracket. A deflector member that is mechanically fastened to the deflector connector in such a way as to make the deflector member rotationally adjustable. The deflector member comprising an LED strip to create a built-in headlight. A set of uprights, comprised by the base plate, that act as retainers for holding a cell phone.

### CROSS-REFERENCE TO RELATED APPLICATIONS

The present application claims priority to application number 2205624.6, filed on Apr. 15, 2022, the disclosure of which is hereby incorporated in its entirety at least by reference.

### BACKGROUND OF THE INVENTION

### 1. Field of the Invention

The present invention relates generally to air deflectors but more particularly to an air deflector for bicycles.

### 2. Description of Related Art

The use of air deflectors on moving vehicles has been known for decades. As the price of oil started to increase in the 1970s, the importance of fuel economy became crucial and deflectors on semi trucks started to be used and more aerodynamic car designs have also been implemented to reduce air resistance and thus improve fuel efficiency. But, for bicycles, where the power source is the human body, there is no fuel economy to be gained, but rather speed and/or lower human energy expenditure. This becomes important in competition. Since most cyclists, whether in competition or not, like to gain speed or lower energy expenditure, there is a growing need for air deflectors that can be easily installed on a bicycle, that is low in costs and actually efficient in reducing wind resistance.

Among the prior art, there are: U.S. Pat. No. 1,042,305 and Italian patent ITSA20120009 that describe an air deflector for a bicycle that is positioned on the handlebar. The deflector notably includes two panels that have fasteners that connect to the handlebar grips.

U.S. Pat. No. 2,401,245 describes an air deflector for a bicycle that is installed partially on the handlebar. The deflector takes the form of a shell that covers the handlebar and the side portions of the front wheel.

U.S. Pat. Nos. 3,891,265, 4,022,487, 4,066,290, and 4,790,555, as well as European patent EP0103837 describe an air deflector for a bicycle that takes the form of a windshield that is equipped with supporting rods or fasteners. The rods or fasteners are connected to the handlebar grips or the front support struts of the wheel. For U.S. Pat. Nos. 4,022,487 and 4,790,555, the windshield has a translucent window. For U.S. Pat. No. 4,066,290, the deflector notably includes a storage compartment.

U.S. Pat. No. 4,800,664 describes a map holder for a motorcycle. The holder takes the form of a housing that is mounted on a plate that rests on rods that are equipped with circular fasteners.

U.S. Pat. No. 5,106,001 and 20060208023 describe a bike mount for a map. The mount notably includes a plate that has an opening. U-shaped fasteners connect to the bike's handlebar.

U.S. Pat. No. 6,481,684, 20030106919, and 20170120980 describe a support plate that can be used for a cell phone, among other things. The plate essentially takes the form of a U or is flat. The plate is connected to a fastener that is placed on a portion of the handlebar.

U.S. Pat. No. 737,328 describes a windshield for a motorcycle that notably includes an air deflector that is essentially triangular in shape.

US industrial designs D245329, D345725, and D431210 illustrate an air deflector for a bicycle that essentially takes the form of a stretched semi-shell. For industrial design D345725, the deflector covers the handlebar grips. For dossier D431210, the deflector covers the front wheel.

US industrial design D354037 illustrates an air deflector for a bicycle that notably has two transparent panels that are joined by a central plate. The deflector is mounted on the handlebar using a plate and circular fasteners.

Chinese patent CN103609030 describes a cell phone holder that takes the form of a plate that is equipped with lateral extensions that hold the device.

Chinese patent CN104071266 describes a cell phone holder that is mounted on a bike's handlebar. The holder notably includes an essentially triangular plate that receives a support that has a reception area for a phone. Circular fasteners connect the support to the bike.

German patent DE102012104266 describes a transport and protection space for a navigation system that is installed on a bicycle handlebar. The space notably includes a conical roof that is mounted on a plate that is installed on the handlebar. The device has a protective surface which is extended from fastening portion, such that display device is partially protected against sunlight, reflections, rain and/or dirt. The protective surface is provided to protect appropriate display device from above a roof which is spaced apart from fastening portion.

### BRIEF SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

It is a main object of the present disclosure to provide for an air deflector that improves the aerodynamic properties of bicycles. For further improve the usefulness of the air deflector a cell phone holder that is protected from rain is also incorporated with the air deflector. Furthermore, the air deflector also incorporates a light band.

In order to do so, the present invention provides an air deflector for bicycles, having:
a) at least one handlebar clamp mechanically fastened to the handlebars of a bicycle;
b) a base plate mechanically fastened to the at least one handlebar clamp;
c) a pivot bracket comprised by the base plate;
d) a deflector connector that is rotationally connected to the pivot bracket;
e) a deflector member that is mechanically fastened to the deflector connector in such a way as to make the deflector member rotationally adjustable;
f) the deflector member comprising an LED strip to create a built-in headlight; and

g) a set of uprights, comprised by the base plate, that act as retainers for holding a cell phone.

In a preferred embodiment, the air deflector is further comprised of a pair of handlebar clamps mechanically fastened to the handlebars of a bicycle.

In yet another preferred embodiment, the air deflector has the base plate further comprised of a set of uprights that act as retainers for holding a cell phone.

In a further preferred embodiment, the set of uprights further comprises an adjustable clamp for securing the cell phone in place.

In still another preferred embodiment, the deflector member further comprises a set of vanes to direct airflow away from the rider.

In yet another preferred embodiment, the set of vanes are adjustable to allow for optimal deflection of airflow.

In still another preferred embodiment, the air deflector further comprises a power source that is connected to the LED strip, wherein the power source is the cell phone held in the set of uprights.

In yet another preferred embodiment, a battery pack that is connected to the LED strip, wherein the battery pack is held in the set of uprights.

The foregoing has outlined rather broadly the more pertinent and important features of the present disclosure so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present disclosure. It should be realized by those skilled in the art that such equivalent structures do not depart from the spirit and scope of the invention as set forth in the appended claims.

### BRIEF DESCRIPTION OF THE SEVERAL VIEWS OF THE DRAWINGS

Other features and advantages of the present invention will become apparent when the following detailed description is read in conjunction with the accompanying drawings, in which:

FIG. 1 Exploded view, according to an embodiment of the invention.

FIG. 2 Partially assembled isometric view, according to an embodiment of the invention.

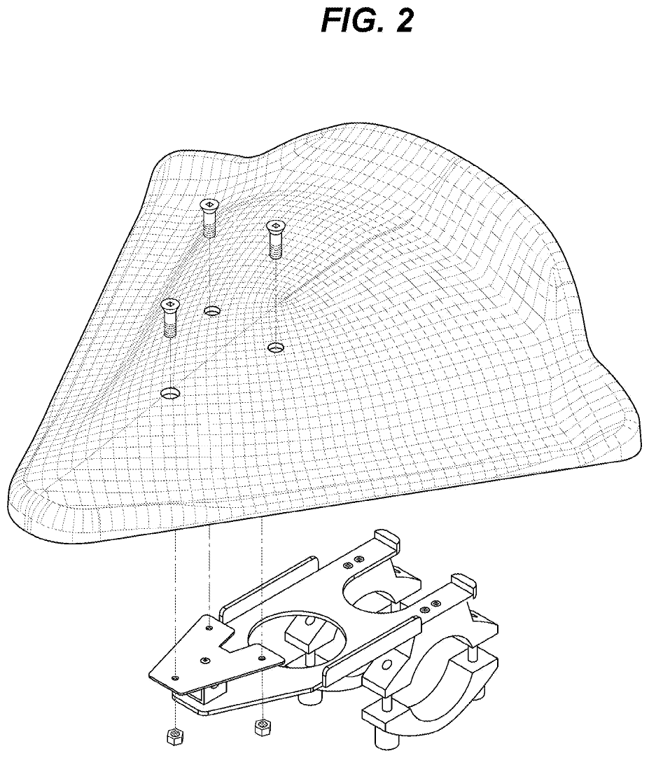

FIG. 3 Side view of the invention installed on a bicycle, according to an embodiment of the invention.

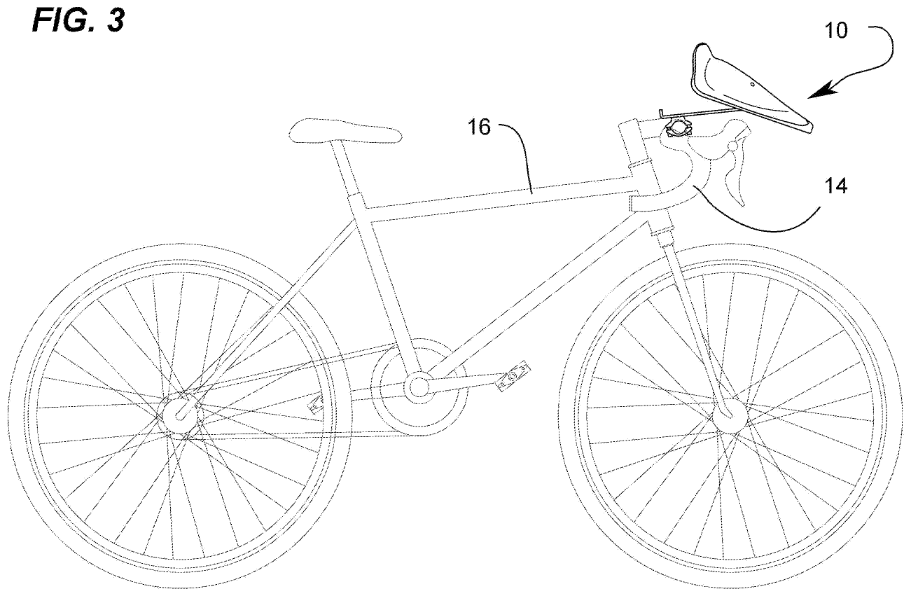

### DETAILED DESCRIPTION OF THE PREFERRED EMBODIMENT

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein.

It is to be understood that the terminology used herein is for the purpose of describing particular embodiments only and is not intended to be limiting. The terms “a” or “an,” as used herein, are defined as to mean “at least one”. The term “plurality,” as used herein, is defined as two or more. The term “another,” as used herein, is defined as at least a second or more. The terms “including” and/or “having,” as used herein, are defined as comprising (i.e., open language). The term “coupled,” as used herein, is defined as connected, although not necessarily directly, not necessarily mechanically, and not permanent. The term “providing” is defined herein in its broadest sense, e.g., bringing/coming into physical existence, making available, and/or supplying to someone or something, in whole or in multiple parts at once or over a period of time. As used herein, the terms “about”, “generally”, or “approximately” apply to all numeric values, whether or not explicitly indicated. These terms generally refer to a range of numbers that one of skill in the art would consider near the stated amount by about 0%, 5%, or 10%, including increments therein. In many instances these terms may include numbers that are rounded to the nearest significant figure.

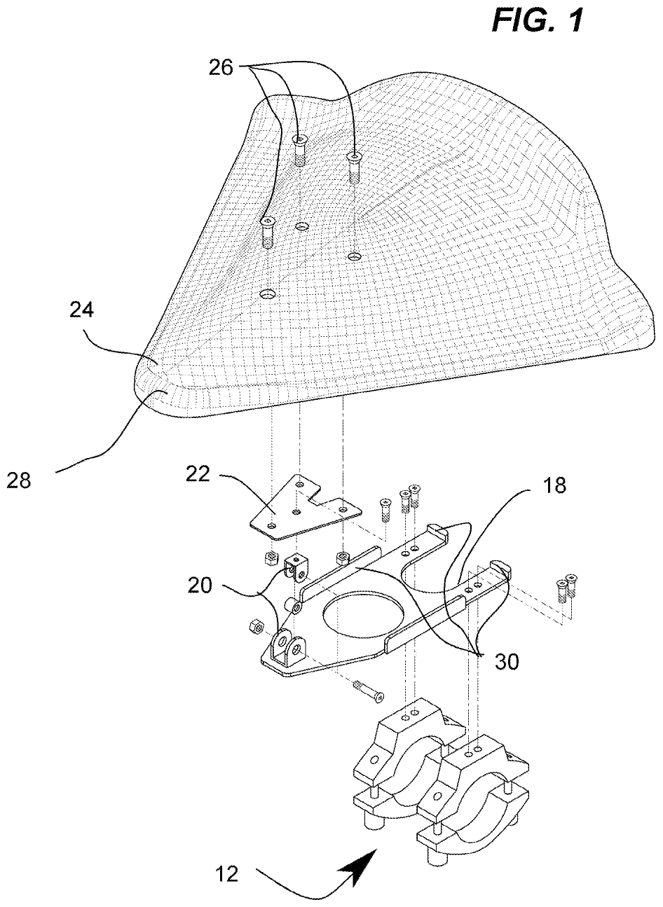

Referring now to FIG. 1, according to a first embodiment, there is provided an air deflector for bicycles 10 comprised of at least one but preferably a pair of handlebar clamps 12 that are mechanically fastened to handlebars 14 of a bicycle 16, as well as mechanically fastened to a base plate 18, which is itself further comprised of a pivot bracket 20 which allows for a deflector connector 22 to be rotationally connected to the base plate 18. The deflector connector 22 is mechanically fastened to a deflector member 24 by way of mechanical fasteners 26 in such a way as to make the deflector member 24 rotationally adjustable.

The deflector member 24 is comprised of an LED strip 28 to create a built-in headlight.

The base plate 18 has a set of uprights 30 which act as retainers for holding a cell phone (not shown). The cellphone can also act as a power source for the LED strip 28.

Although the invention has been described in considerable detail in language specific to structural features, it is to be understood that the invention defined in the appended claims is not necessarily limited to the specific features described. Rather, the specific features are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) are not used to show a serial or numerical limitation but instead are used to distinguish or identify the various members of the group.

1. An air deflector for bicycles, comprising:
a) at least one handlebar clamp mechanically fastened to the handlebars of a bicycle;
b) a base plate mechanically fastened to the at least one handlebar clamp;
c) a pivot bracket comprised by the base plate;
d) a deflector connector that is rotationally connected to the pivot bracket;
e) a deflector member that is mechanically fastened to the deflector connector in such a way as to make the deflector member rotationally adjustable;
f) the deflector member comprising an LED strip to create a built-in headlight; and
g) a set of uprights, comprised by the base plate, that act as retainers for holding a cell phone.

2. The air deflector of claim 1, further comprising a pair of handlebar clamps mechanically fastened to the handlebars of a bicycle.

3. The air deflector of claim 1, wherein the base plate is further comprised of a set of uprights that act as retainers for holding a cell phone.

4. The air deflector of claim 3, wherein the set of uprights further comprises an adjustable clamp for securing the cell phone in place.

5. The air deflector of claim 1, wherein the deflector member further comprises a set of vanes to direct airflow away from the rider.

6. The air deflector of claim 5, wherein the set of vanes are adjustable to allow for optimal deflection of airflow.

7. The air deflector of claim 1, further comprising a power source that is connected to the LED strip, wherein the power source is the cell phone held in the set of uprights.

8. The air deflector of claim 1, further comprising a battery pack that is connected to the LED strip, wherein the battery pack is held in the set of uprights.
